(19) United States
(12) Patent Application Publication
(10) Pub. No.: US 2026/0265002 A1
(43) Pub. Date: Sep. 10, 2026

(54) INTRALOGISTIC CONVEYOR ARRANGEMENT

(71) Applicant: INTERROLL HOLDING AG, Sant'Antonino (CH)

(72) Inventor: Christian Ripperda, Hückelhoven (DE)

(21) Appl. No.: 18/873,698

(22) PCT Filed: Jun. 12, 2023
(86) PCT No.: PCT/EP2023/065597

§ 371 Date: Dec. 10, 2024

(30) Foreign Application Priority Data
Jun. 22, 2022 (EP) 22180381.0
Dec. 23, 2022 (EP) 22216543.3

(51) Int. Cl. B65G 47/50; B07C 3/08; B65G 43/10

(52) U.S. Cl. CPC B65G 47/50; B07C 3/08; B65G 43/10

(57) ABSTRACT

Intralogistic conveyor arrangement adapted to convey an object to a selected destination from a plurality of destinations, the conveyor arrangement having a plurality of conveyor zones, wherein at least one of the conveyor zones is a sorting zone with a sorting controller to convey the object selectively from an inlet to a selected outlet; further wherein zone controllers are adapted to receive object data sets via a data connection with a data broker to control operation of the related zone.

### TECHNICAL FIELD

The invention refers to an intralogistic conveyor arrangement.

### BACKGROUND OF THE INVENTION

In a conventional intralogistic conveyor arrangement, e.g. shown in U.S. Pat. No. 7,996,104 B2, a plurality of conveyor zone are provided. A plurality of local zone controllers control operation of the zones based on overall control signals provided by an central programmable logic controller (PLC). Thereby the local zone controller provides start/stop and speed control of a motorized roller according to messages from the PLC.

Scanners provided along the zones provide identification data relating to objects to be conveyed. These identification data are sent via data connection to the PLC. PLC has access to an object data base, which provides destination data based in the identification of the objects. Based on the acquired destination data the PLC provides operation instructions to a local zone controller, how to handle said object, i.e. to which of the outlets said object is to be conveyed. Consequently the routing decisions for individual objects are done within the PLC and are provided to the zone controllers. The zone controllers control the zone actuators in accordance with the provided routing decisions.

EP 3 222 564 B1 discloses a conveyor, which operates according to a more decentral approach. Here an object from a start position to a target destination. The conveyor comprises a plurality of zones into which the conveyor is divided, the object being conveyed across the zones. Each of the zones comprising a linear conveyor zone that linearly conveys the object; a conveyor direction changing zone selecting a conveyor direction of the object to send out the object in the selected conveyor direction; a conveyance destination storage unit that is configured temporarily to store the conveyance destination information; an information receiving unit that is configured to receive the conveyance destination information from an upstream zone; and an information transmitting unit that is configured to transmit the conveyance destination information to a downstream zone. The conveyor is configured to transfer conveyance destination information from the upstream zone to the downstream zone with movement of the object across the zones. Based on the conveyance destination information received from the upstream zone routing of the object is controlled locally by actual zone.

US 2002/0045969 A1 discloses an apparatus for sorting units of material. A central sort logic processor, e.g. a PLC, is provided which multicasts an output signal through the a network bus to a plurality of actuators. The actuators are controlled directly by the central sort logic processor.

EP 2 370 331 B1 discloses a material flow system having a plurality of multidirectional conveyor modules. Each module has a conveying hardware, in particular motor driven rollers, and a controller, controlling operation of the hardware and communicating with other modules. The modules can operate fully autonomous without being connected to any central control unit. The modules can be attached to neighbouring modules, to transfer an object to be conveyed from modules to the neighbouring module and vice versa at respective ports. The ports serve as inlets and outlets for the objects to be conveyed. Each port is equipped with a data interface, via which the neighbouring modules are data connected directly with each other. No bus connection is provided between the modules. Any amendments of the spatial relation between the modules can easily be recognized by the module controls. A topography of the modules and any change of the topography can be determined automatically.

US 2005/065642 A1 discloses a transport system for transporting items to a destination on predefined transport routes. The predefined transport routes having a plurality of branching locations. A master controller setting for each transported item the destination and a transport route associated with the destination. Consequently any local controllers control the branching locations based on the transport route provided by the master controller.

### SUMMARY OF THE INVENTION

It is the object of the present invention to provide an improved method of controlling a conveyor arrangement.

According to the invention a central data broker is provided providing object data sets to whom it may concern. The object data set belongs to an real object which is conveyed and sorted in the conveyor arrangement. The data may comprise any kind of values, which support the local zone controller in their operation.

In particular instead of providing explicit sorting instruction by a PLC, the sorting decisions are performed locally in the sorting controllers with help of the data. In simple terms, the object knows its destination and tells the sort controllers what this destination is via its object data set. Consequently the sorting controllers know which path to take at the local sort segment and set the local sort segment accordingly. Thus, routing decisions are made at the local level based on the object data, instead of asking a central PLC for individual routing decisions.

In general it is to be differentiated between two kind of sensors within the context of the present description. One the one side a presence sensors can simply provide information whether any object is present in the sensor field; a presence sensor usually does not provide any data related to the identity of the detected object. On the other side a scanner can provide identification data, e.g. a bar code or QR-code information.

The term “belong”/“belonging” expresses the relationship between the real conveyed object and the object data set in both directions. The object data set thereby characterizes and provides detail information related to the belonging conveyed object; the conveyed object is characterized by the belonging object data set.

When talking about a data set, it is not essential, that under the term “data set” it is always meant the complete data set. E.g. a specific sorting segment may not be interested some values of the data set, consequently the controller may store merely a selection of the complete data set which is also considered as being a data set.

In contrast to the prior art, the data broker merely provides the destination associated to a certain object. Any decision, which route needs to be taken is taken by the local zone controllers. So there is no need to programming any a PLC (e.g. a master controller) with the topology of the zones and destinations within the conveyor arrangement.

In general, the term routing condition is to be considered different to the term destination or destination information. With destination/destination information the location is indicated, to which an object has to be conveyed. The destination does not comprise any information, through which route this destination is to be reached. In contrast there, the routing condition may comprise single information, about paths or direction decisions, which needs to be taken at individual locations. The routing condition does not comprise any indication of the destination.

### BRIEF DESCRIPTION OF THE DRAWINGS

A non-limiting example of the invention is described with respect to the figures, which show

FIG. 1 shows an exemplary conveyor zone used within the invention;

FIG. 2 schematically, embodiments of conveyor zones having different inlet/outlet configurations;

FIG. 3 schematically, an inventive conveyor arrangement;

FIG. 4 schematically, a look-up table, containing path condition;

FIG. 5 a flow chart of steps during conveying an object from a feed in station to a destination.

FIG. 6 an exemplary object data set at step S2;

FIG. 7 another look up table used at step S4;

FIG. 8 the exemplary object data set at step S6;

FIG. 9 the exemplary object data set at step S7;

FIG. 10 the exemplary object data set at step S9;

FIG. 11 schematically, parts of the conveyor arrangement of FIG. 3, amended with an additional sorting branch;

FIG. 12 a look up table supporting the amendments according FIG. 11, and

FIG. 13 schematically, parts of a conventional conveyor arrangement.

### DETAILED DESCRIPTION

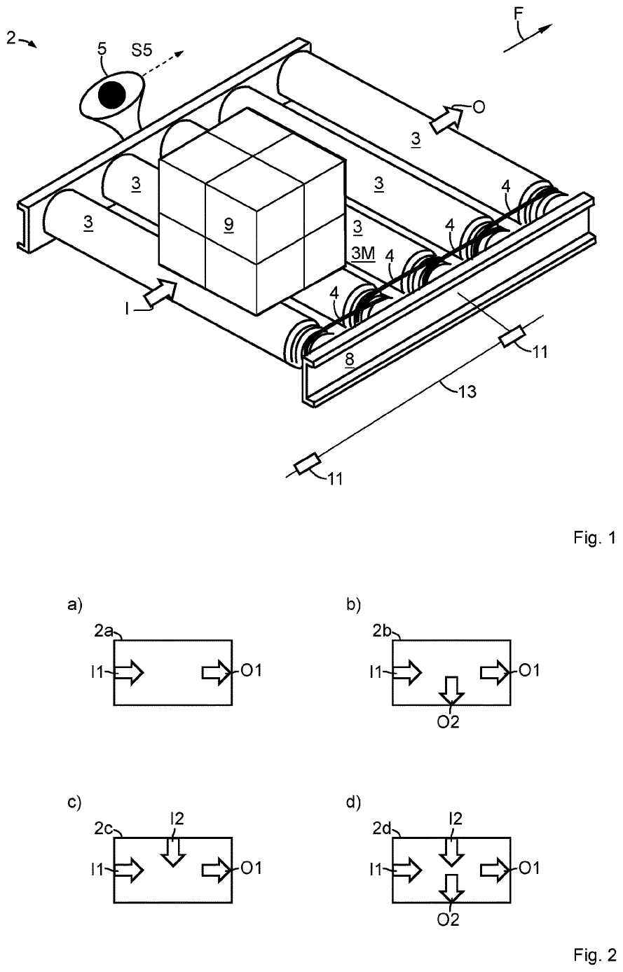

FIG. 1 shows an exemplary conveyor zone 2, having several conveyor rollers 3 which are driven together. For this purpose, one of the conveyor rollers 3 is designed as a motor-driven conveyor roller 3M. The motor-driven conveyor roller 3M is driven in particular by a three-phase motor arranged in the conveyor roller 3M. Via one or more drive connectors 4, e.g. a drive belt, the conveyor rollers 3 of a conveyor zone 2 are drive-connected to each other and are jointly driven by the motor-driven conveyor roller 3M. An object is linearly conveyed from an inlet I to an outlet O.

By means of a presence sensor 5, the presence of a conveyed object 9 arranged on the conveyor zone can be determined. The presence sensor 5 does not have to cover the entire conveyor zone 2; it is sufficient if the presence of a conveyed object 9 within a partial area of the conveyor zone 2 is detected by the presence sensor 5. The presence sensor 5 thereby generates a sensor signal S5, which is connected via a signal line (not shown) to a zone controller 11 presented further below. Presence detection can also be performed without an explicit sensor and can be derived from other raw data. For example, there are already approaches to derive the presence of a conveyed material on the conveyor zone from other data, e.g. from the course of the current intensity in a conveyor zone.

The conveyor rollers 3 and the presence sensor 5 are attached to a common support frame 8. The conveyor rollers 3 of several conveyor zones 2 can be attached to a common support frame 8.

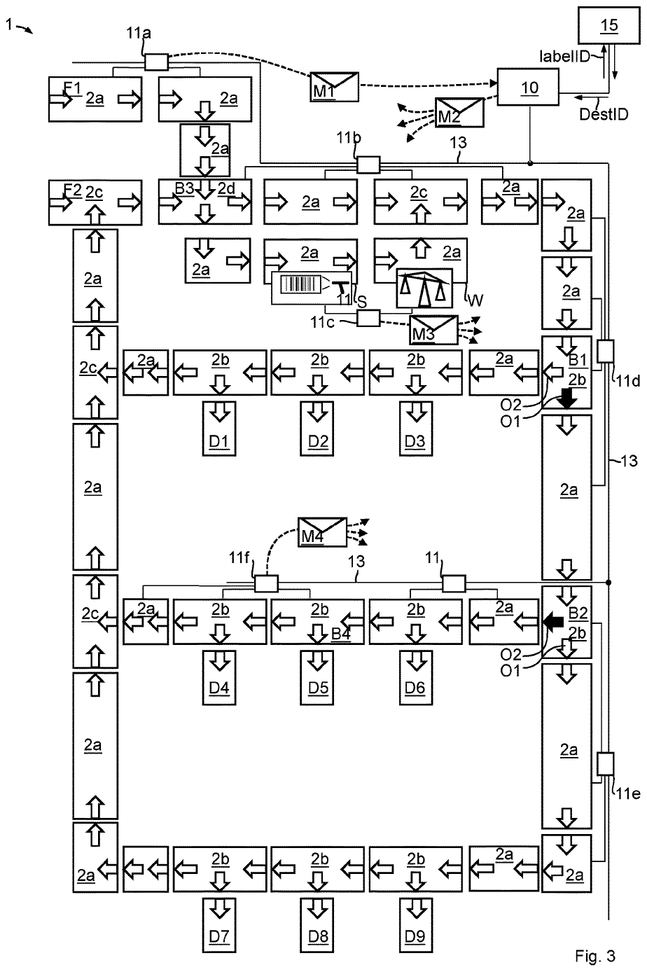

The motor-driven conveyor rollers 3M are each controlled by at least one or a plurality of zone controller 11. A single zone control 11 can control the motor-driven conveyor rollers of several conveyor zones 2. Several such zone controllers 11 are arranged in a conveyor arrangement 1 (see below in FIG. 3), which communicate with each other via a bus connection 13.

The zone controllers 11 control the motor-driven conveyor rollers 3M in such a way that the successively approaching conveyed goods 9 do not collide with each other. The control takes place in such a way that essentially only one conveyed object 9 is present per conveyor zone 2. However, slight overlaps may occur. For example, an upstream conveyed material may already enter a downstream conveyor zone from an upstream conveyor zone even though a downstream conveyed material has not yet left this downstream conveyor zone completely. Among other things, the sensor signals S5 of the presence sensors 5 serve as input variables here, although it is ensured that the two conveyed goods do not then touch and thus damage each other.

FIG. 13 shows a conventional conveyor arrangement, where conveyor zone 2 as described previously are used. A plurality of zone controllers 11 control operation of the zones 2 based on overall control signals provided by a PLC 12.

Scanners provided along the zones provide identification data relating to objects to be conveyed. These identification data are sent via data connection 13 to the PLC 12. PLC has access to an object data base, which provides destination data based in the identification of the objects. Based on the acquired data the PLC 12 provides operation instruction to a local zone controller 11, how to handle the object, i.e. to which of the outlets said object is to be conveyed.

In one embodiment, the zone controllers 11 are connected to a common higher-level object data broker 10, in particular via the bus connection 13, with which the zone controllers 11 are also connected to one another.

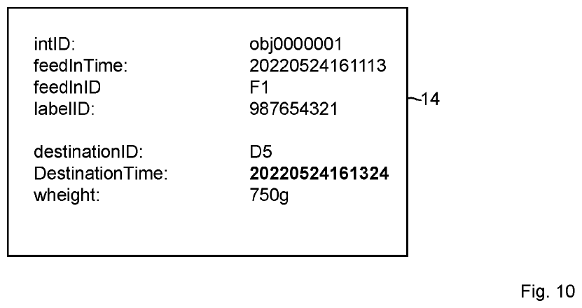

In the following course of the invention, reference is made to conveyor zones, using a schematic representation of said conveyor zone as shown in FIG. 2. Here FIG. 2 represents schematically the conveyor device of FIG. 10, showing one first inlet 11 and one first outlet 01. No more inlets and outlets are provided. The conveyor zone can be curved.

FIG. 2, panel b) shows the representation of another conveyor zone 2b having an extended scope of operation. Here in addition to the conveyor zone 2a of FIG. 2, panel a), the conveyor zone 2b has an additional, second outlet O2. The object 9 can be conveyed selectively from said first inlet 11 to one of the first and second outlets O1, O2.Co

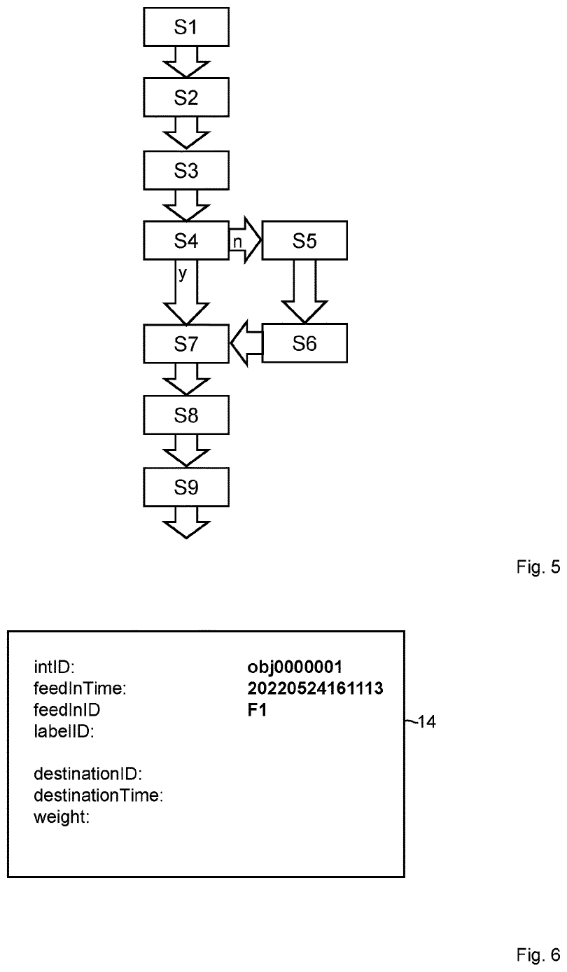

As an example, the conveyor zone of FIG. 2, panel b) can be formed by a conveyor zone as shown in FIG. 1, which additionally is provided with a transfer device 20 as described with reference to FIG. 5 of EP 3 222 564 B1.

FIG. 2, panel c) shows the representation of a conveyor zone 2c having an extended scope of operation. Here in addition to the conveyor zone 2a of FIG. 2, panel a), the conveyor zone 2b has an additional second inlet 12. Objects 9 can be conveyed from one of said first and second inlets 11, 11 to said first outlet O1. Such Conveyor zones are also known as “a merge”.

The transfer device as described with reference to FIG. 2 panel b) may be suitable also to provide said additional second inlet 12.

FIG. 2, panel d) shows the representation of a conveyor zone 2c having an extended scope of operation. Here in addition to the conveyor zone 2a of FIG. 2 panel a) the conveyor zone 2b has an additional second inlet 12 and an additional second outlet 02 and is an example as a combination of the embodiments of FIG. 2 panels b) and c).

All conveyor zones are controlled by a zone controller 11 as shown in FIG. 1, in particular wherein one zone controller device may be adapted to control the operation of more than one zones 2.

FIG. 3 shows an example of a conveyor arrangement 1. The conveyor arrangement 1 comprises a plurality of conveyor zones 2 as described above. Via the conveyor zones 2 objects are conveyed from at least one feed in station F1, F2 selectively to one of a plurality of destinations D1-D9. The conveyor arrangement comprises conveyor zones 2a-d of different embodiments provided.

The functionalities of all conveyor zones 2 are controlled by said zone controllers 11. Due to a better visibility only a few (not all) zone controllers 11 are shown in FIG. 3.

At least some of the conveyor zones 2b, 2d have more than one outlets O1, O2. In the following such conveyor zones having at least two outlets are called sorting zones 2b, 2d.

Zone controller 11 controls the sorting functionality of the sorting zones 2b, 2d. Here the zone controller 11 provides clear instructions to the sorting zone 2b, 2d, via which of the plurality of outlets O1, O2 a currently conveyed object 9 is to be conveyed.

For better illustration and description, some of the sorting zone in FIG. 3 are additionally provided with identifications, e.g. see sorting zones B1, B2, B3.

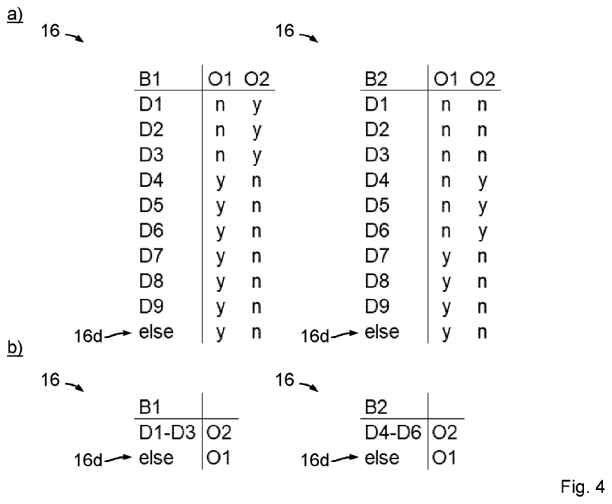

FIG. 4 shows exemplary look-up tables 16. A look-up table 16 provides information of the routes with respect to an individual sorting zone. In particular in the look-up table it is stored, which outlets of a certain conveyor zone leads to which destinations within the conveyor arrangement.

In the following this information which is independent from an individual object to be conveyed, is called “routing condition”. As apparent from FIG. 3, an object traveling to a certain destination needs to pass several sorting zones 2b, 2d. At each sorting zone the object needs to be routed via one of the plurality of outlets. The routing conditions are stored locally in the zone controller.

As an example, any object intended for destination D5 needs to pass-among others-sorting zones B1 and B2. At sorting zone B1, outlet O1 is to be used; at sorting zone B2, outlet O2 is to be used (see also FIG. 2, panel b)), the respective outlets are marked with filled arrows.

As another example and, any object 9 intended for destination D1 needs to pass sorting zone B1 but not sorting zone B2. At sorting zone B1, outlet O2 is to be used (see also FIG. 2 panel b)).

The look-up tables in FIG. 4 reflects the above general routing conditions. Here FIG. 4, panels a) and b) show two different embodiments of look up tables, from which it should be obvious, that there are many ways to provide the routing conditions is such tables.

So based on a destination information linked to an object, a zone controller 11 can issue a signal to a related sorting zone, which results in the sorting action of the object to the correct outlet O1, O2.

FIG. 5 shows a flowchart of the steps, occurring during conveying an object from the feed in station F to a destination D.

At step S1 an object to be conveyed is fed into the conveyor arrangement e.g. at feed in station 1. A zone controller 11a, which controls operation of said feed in station F1, sends a first message M1 to said object data broker 10 via bus 13 (see FIG. 3). Within said message M1, the zone controller 11 provides information, that an object having has been fed in. Message M1 also contains an ID of said feed in station F1 (feedInID, see below) and a time stamp of date and time of said feed in event (feedIn Time, see below).

In step 2 a new object data set 14 is established by object data broker 10. The object data set 14 comprises information about the object to be conveyed, which was recently fed in at feed in station F1. FIG. 6 shows an exemplary object data set 14 established in step S2.

The object data set 14 comprising the following data values:
intID: an explicit unique internal identification used to identify each of the objects conveyed within the arrangement. The identification can be a counter, which corresponds to the position within the sequence of all conveyed objects. The explicit unique internal identification can be substituted by an implicit internal identification as described below
feedInTime: a time stamp, indicating the calendar day (here 24 May 2022) and day time (here 16:11:13), when the object was feed in at the feed in station.
feedInID: a unique identification, identifying the feed in station, e.g. feed in station F1, where the object was fed in.
labelID: a unique label identification, which is provided as machine readable information on the object 9 itself. Usually said label ID is provided on the object as printed code, like a barcode or a QR code. In an embodiment said label identification may be other than printed e.g. a RFID code provided by a RFID tag attached to the object.
destinationID: a unique identification, identifying the destination within the conveyor arrangement, to which the object is to be conveyed.
destination Time: a time stamp, indicating the calendar day and day time, when the object has arrived at said destination.
weight: the weight of the object to be conveyed.

The combination of values of feedIn Time and feedInID provides already an implicit unique internal identification, since only one object can be fed in at once at a single feed in station. Said combination can be used in the here and in all other steps within the scope of this description as an internal identification instead of an explicit internal identification.

In step 3 the object data broker 10 sends out a second message M2 to all zone controllers 11, including zone controller 11a of said feed in station F1. In said second message M2, said first object, which has just entered via the feed in station F1 is introduced to all zone controllers 11. The second message M2 contains a copy of said object data set referring to said object as represented in FIG. 6.

During steps S2 and S3 most of the data fields are empty (means also: filled with a placeholder). During the further course of the processing, the data fields are filled more and more with data, which are important for the further conveying process.

The object 9 is now conveyed from the feed in station F1 in direction of a sorting zone B3. Thereby a first zone controller 11a—controlling the fed in station F1, where the object has been fed in—provides the internal identification to the zone controller 11b of the subsequent conveyor zone. Subsequent controller 11b now knows, that the object data set of “obj0000001” is linked to the next arriving object.

Subsequent zone controller 11b needs to perform a routing decision. Therefore zone controller 11b analyses object data set of “obj0000001” which does not comprises any values of “destinationID” and “labelID”; also no value is set for “weight”. As a consequence, it is currently unknown, which object obj0000001 is (from an external view) and to which destination D it is to be conveyed. Further the weight is unknown.

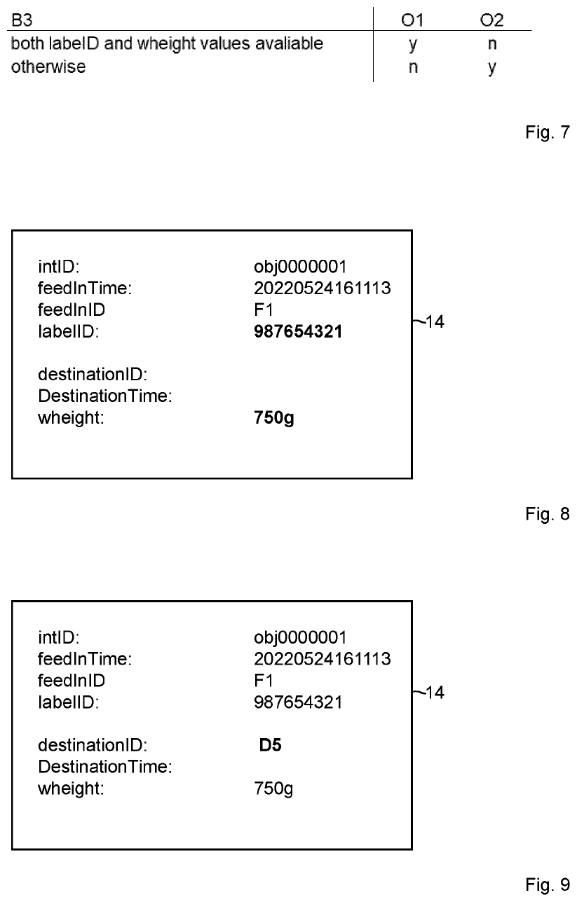

Controller 11b has access to a look up table as shown in FIG. 7, which contains routing conditions for sorting zone B3. Since at least one of the labelID and the wight value are not available in the related object data set 14, the object needs to take outlet O2, which directs the object to a barcodes scanner S and weighing station W. Consequently in a step S4 it is checked, whether predetermined values of said object data set are available, and based on that check a sorting decision is made.

In step S5 and as a consequence of the routing decision of step 4 the object is conveyed via second outlet O2 of sorting zone B3 to guide the object to stations S, W, where one or more missing data of said object data set values can be acquired.

So in step S6 (See FIG. 5) the scanning station S and the weighing station W provides the missing values for labelID and weight. In step S6 also the zone controller 11c controlling stations S, W sends out a third message M3 to object data broker 10, containing the values labelID “987654321” and weight “750 g” related to intID “obj0000001”.

Also in step S6 object data broker 10 adds the recently acquired values to the object data set 14, so that the updated object data set 14 comprises the values as shown in FIG. 8. The updated object data set 14 is sent out by object data broker 10 as a new second message M2.

In principle the second message M2 can be considered as a global informing message M2, where the object data broker 10 sends updated object data sets to a plurality of zone controllers within the arrangement. So second messages M2 are broadcasted via the network to all zone controllers; zone controller who are interested in the information about the object data sets can receive the message and can store the data relating in a local memory for the later use during controlling.

Second messages M2 relating to a certain object data set belonging to a certain object to be conveyed can be broadcasted at different instances by the object data broker 10, e.g. always, when an object data set is updated in the object data broker 10, at regular intervals and/or upon request from a zone controller 11, etc. As a consequence, the object data sets are send out to a controller independent from an actual conveying operation.

During scanning also a destination information can be scanned by the scanner, in case a destination information is provided at the object itself, e.g. in a printed manner on the object. The destination information may comprise any explicit destinationID or can comprise an implicit information which provides a link to the destinationID.

In step S7, the destination information in particular destinationID will be allocated to the object data set 14. In an embodiment, the arrangement conveyor has access to a database 15, which provides a link between the destinationID based on the labelID. As soon as the object data broker has determined the destinationID, a new second message M2 is sent out to all zone controllers 11 comprising an updated object data set as shown in FIG. 9, where the object data set comprises now also a value “D5” as destinationID. Consequently all zone controllers are set into knowledge, that belonging object 9 needs to be conveyed to selected destination D5.

In step S8 the object 9 is conveyed in direction of the destinations, thereby approaching one of sorting zones B1, B2. The zone controller 11d, 11e, each of which controls operation of a sorting zone B1, B2, has already previously received the lasted update of the object data set within a new second message M2. In case the related object will approach the respective sorting zone, the respective zone controller 11d, 1e can control sorting operation of the sorting zones in a manner, that the related object is conveyed in direction to destination D5, as previously described.

In a step 9 the object is finally sorted into destination D5 at a sorting zone B4, which ultimately leads into the destination D5. Also controller 11f controlling sorting zone B4 operates with the help of a look-up table, as describe previously. Now the object is finally delivered to the destination D5.

When said object 9 is finally delivered to the correct destination by sorting zone B4, the controller 11f controlling the last sorting zone before the destination sends or out a fourth message M4 to object data broker 10.

The fourth message M4 containing a time information, indicating the time when the object has been transferred to the correct destination D5. Now the object data broker 10 can update the object data set 14 as shown in FIG. 10 with a value destination Time and may send out a new second message M2 containing the updated object data set.

Now the object data set 14 contains all relevant values in view of the conveying/sorting operation. Thereby the object data set includes values which clearly indicates that the sorting operation has been finished, since the main values are set with a value. In particular a value is set, indicating that the object has been delivered to a destination.

The object data set 14 relating to the delivered object 9 is now of no relevance anymore for the operative components of several conveyor zones. In particular as soon as zone conveyor receives said updating second message M2, the object data set belonging to said delivered object can be deleted from local memories of the operative zone controller in order to clear memory for new object data sets belonging to next objects to be conveyed.

In addition it is not required, that all sorting controllers 2b, 2d store all broadcasted object data sets. Individual sorter controller can decide on their own, whether to store or not to store any broadcasted object data set. Subsequent, there is an example, where storing may be not required.

According to the look up 16 table of FIG. 4 panel b), at sorting segment B1 all objects intended to destinations D1, D2 and D3 must take outlet O2. All other objects (“else”) must take outlet 01. Since the routing condition comprises a default condition 16d for all other destinations it is merely essential, that sorting controller 11d detects, if any object falls under a non-default case. The object data set 14 shown in FIG. 9 indicates that the belonging object is intended for destination D5, which is covered according to FIG. 5b by said default condition 16d. The sorting controller 11a is adapted to sort unknown objects (no object data set is provided) in the same manner object falling under a default case. Consequently, an unknown object at sorter segment B1 is sorted in outlet O1 by sorting controller 11d. So for proper operation of sorting segment B1, related zone controller 11d controlling sorting segment B1 does not require to store said object data set 14 as shown in FIG. 9.

The situation is different for sorting segment B2, see routing condition according to FIG. 4b, right side. Here the destination D5 falls under the explicit routing condition, does not fall under the default case. As a consequence, the sorter controller needs to know that the object belonging to object data set of FIG. 9 is to be sorted to outlet O2. Therefore the object data set 14 of FIG. 9 is essential for operation and will be stored in sorter controller 11f controlling to sorting segment B4.

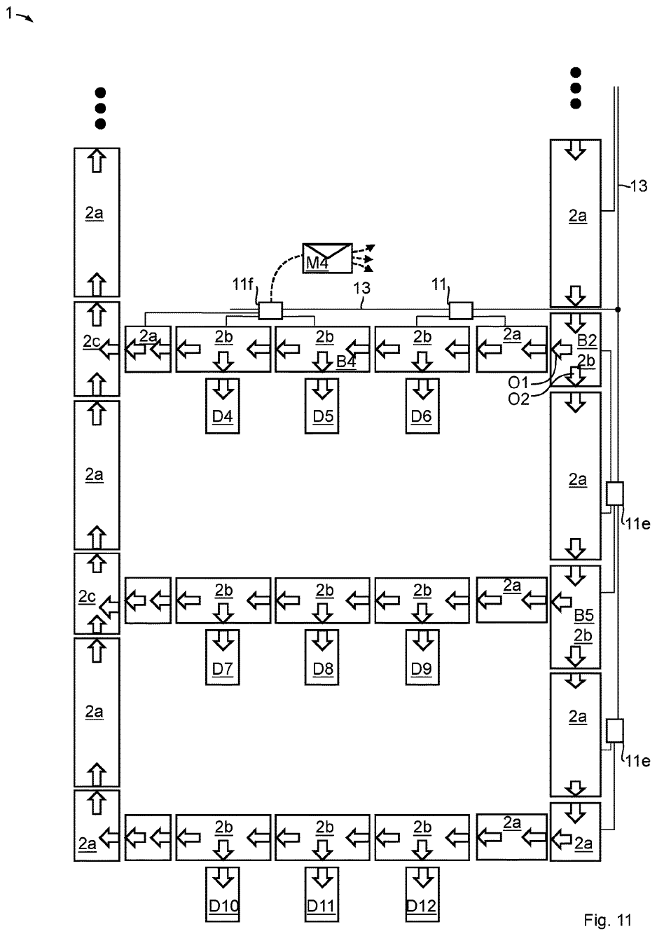

FIG. 11 shows parts of the conveyor arrangement according to FIG. 3, where an additional destination branch comprising additional destinations D10 to D12 has been inserted. To support the additional destinations an additional sorting segment B5 is inserted as well to support sorting operation between destinations D7 to D9 on the one hand and newly added destinations D10 to D12 on the other hand.

The decentral structure of the conveyor arrangement enable that merely simple database adaptation need to be performed. The look up tables shown in FIG. 4 are still valid, since the default condition 16d provides already sufficient instructions to support the newly added destinations D10-D12 at sorter segments B1 and B2. Here the newly added destinations are fully covered by the default cases 16d.

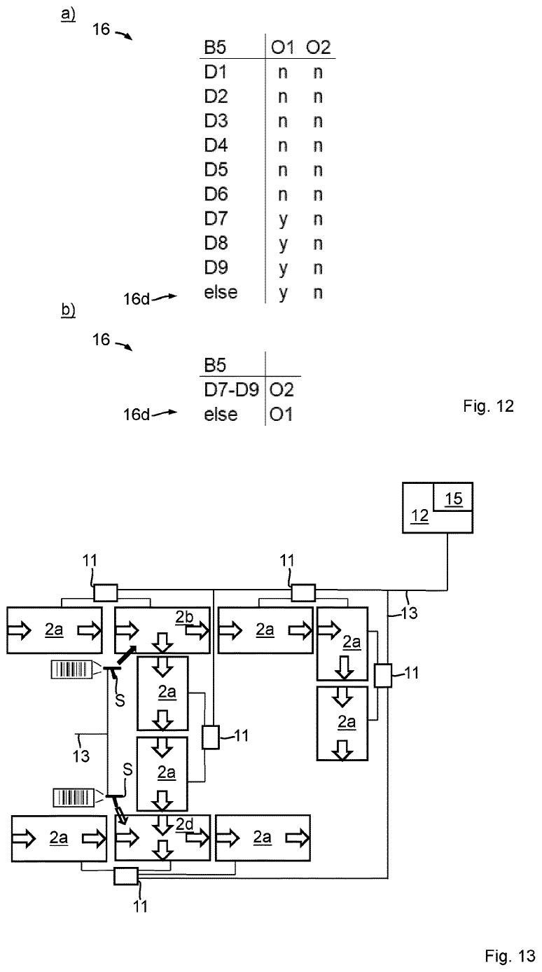

Now merely added sorter segment B5 needs to be configured by generating a new look up table 16 as shown in FIG. 12a or alternative format in FIG. 12 panel b).

No adaptions need to be done at data broker 12.

### LIST OF REFERENCE SIGNS

1 conveyor arrangement
2a . . . d conveyor zone
3 conveyor roller
3M motorized roller
4 connector
5 Presence sensor
8 support frame
9 conveyed object
10 object data broker 11 zone controller
12 central programmable logic controller (PLC)
13 bus connection
14 object data set
15 data base
16 look up table
I inlet of conveyor zone
O outlet of conveyor zone
D destination
F feed in station
S scanning station/scanner
W weighing station

1. Intralogistic conveyor arrangement (1), adapted to convey an object (9) from at least one feed in station (F) selectively to a selected destination (D5) from a plurality of destinations (D1-D12),
the conveyor arrangement (1), comprising,
a plurality of conveyor zones (2), each conveyor zone (2) is adapted to convey an object (9) from an inlet (I) of said conveyor zone (2) to an outlet (O) of said conveyor zone (2),
a plurality of zone controller (11), adapted to control the operation of the conveyor zones (2);
wherein said conveyor zones (2) are arranged in a manner, that said object (9) can be transferred from an outlet (O) of a previous conveyor zone (2) to an inlet (I) of a subsequent conveyor zone (2);
wherein at least one of said conveyor zones is a sorting zone (2b, 2d) having at least two outlets (O1, O2), wherein a zone controller (11) controlling a sorting zone (2b, 2d) is a sorting controller (11b, 11d, 11e),
wherein each sorting controller (11b, 11d, 11e) is adapted to control the sorting zones (2b, 2d) in a manner so that said sorting zone (2b, 2d) conveys said object selectively from an inlet to a selected outlet (O1, O2) from said at least two outlets (O1, O2);
characterized in
that said Intralogistic conveyor arrangement (1) comprising
an object data broker (10), connected to each of the zone controller (11) by means of a data connection (13);
wherein said zone controllers (11) are adapted to receive object data sets (14) via a data connection (13) from said data broker (10),
wherein said object data sets (14) contain information related to a belonging conveyed object (9), wherein said zone controllers (11) are adapted to control operation, in particular sorting operation, of the related zone based on said object data sets (14) provided by said data broker (10).

2. Intralogistic conveyor arrangement (1) according to claim 1,
characterized in
that said object data set (14) provided by said object data broker (10) contains an destination information (destinationID) indicating the selected destination (D5) to which the related object is to be conveyed,
wherein said sorting controller (11b, 11d, 11e) is adapted to control said sorting zone (2b, 2d) based on said provided destination information in a manner so that said sorting zone (2b, 2d) conveys said object to a selected outlet, where the selected outlet leads to the selected destination (D5).

3. Intralogistic conveyor arrangement (1) according to claim 1, characterized in
that said object data set (14) is not containing any routing information indicating which of the plurality of outlets are to be used within an individual sorting operation, and/or
that the sorting controller (11b, 11d, 11e) is adapted to use from the object data set (14) merely the destination information (destinationID) for controlling an individual sorting operation without using any routing information provided by in the data set.

4. Intralogistic conveyor arrangement (1) according to claim 1,
characterized in
that said sorting controller (11b, 11d, 11e) has access to a routing condition (16), in particular a look-up table (16),
the routing condition (16) contains information, which of said outlets lead to which of said destinations.

5. Intralogistic conveyor arrangement (1) according to claim 1,
characterized in
that said routing condition (16) comprising a default condition (16d) valid for non-specified destinations (“else”).

6. Intralogistic conveyor arrangement (1) according to claim 1,
characterized in
that said sorting controllers (11b, 11d, 11e) are adapted to store said routing condition (16) locally within said sorting controller (11b, 11d, 11e).

7. Intralogistic conveyor arrangement (1) according to claim 1,
characterized in
that at least one of the sorting controllers (11a) is adapted to a control sorting operation in the following manner:
check the object data set (14) relating to a specific object (9) of a specific missing value (weight; labelID);
depending on the result of the check, control sorting operation of a sorting zone in a manner so that the object is directed to a zone (S, W), where said missing value (weight; labelID) can be acquired.

8. Intralogistic conveyor arrangement (1) according to claim 1,
characterized in
that said object data set (14) is broadcasted by said data broker (10) to a plurality of zone controllers (2) in an undirected manner independently from the position of the belonging object (9).

9. Intralogistic conveyor arrangement (1) according to claim 1,
characterized in
that said object data set (14) is broadcasted by said data broker (10) to at least one zone controller (2) independent from an actual conveying operation referring to the belonging object (9).

10. Intralogistic conveyor arrangement (1) according to claim 1,
characterized in
that said object data set (14) is broadcasted by said data broker (10) to a plurality of zone
as soon as the data object set has been updated with a new value and/or
at regular time intervals and/or
upon request from a zone controller.

11. Intralogistic conveyor arrangement (1) according to claim 1,
characterized in
that said sorting controllers (11b, 11d, 11e) are adapted to store said routing condition (16) locally within said sorting controller (11b, 11d, 11e) independently from the actual position of the belonging object.

12. Intralogistic conveyor arrangement (1) according to claim 1,
characterized in
that said zone controller (11), in particular sorting controllers (11b, 11d, 11e), is adapted to check from the object data set (14), whether it is essential to store said object data set in order to support a subsequent sorting process; in particular if the conveyor zone related to the sorting controller (110b, 11d) is on a route of the belonging object to the selected destination.

13. Intralogistic conveyor arrangement (1) according to claim 12,
characterized in
that in case said previous step of checking leads to the result, that storing said object data set is not essential to support operation at the relating segment, the controller (11) decides to
selectively not to store said object data set (14) in the local sorting controller (11b, 11d) and/or
selectively delete said object data set from the local sorting controller (11b, 11d).

14. Intralogistic conveyor arrangement (1) according to claim 1,
characterized in
that in addition to the zone controller, the intralogistic conveyor arrangement does not comprise a central programmable logic controller (PLC), in particular adapted to control sorting operations of the sorting zones.
